(19) United States
(12) Patent Application Publication
(10) Pub. No.: US 2003/0141361 A1
(43) Pub. Date: Jul. 31, 2003

(54) Monetary transaction information delivery system

(75) Inventors: Thuong Van Nguyen, Petaluma, CA (US); Sheng-Roan Kai, Tucker, GA (US)

Correspondence Address: Thuong Nguyen, 2046 STRATFORD DR., MILPITAS, CA, 95035, US

(73) Assignee: Advanced Wireless Information Services Corp.

(21) Appl. No.: 10/055,765

(22) Filed: Jan. 25, 2002

(51) Int. Cl. G06K 5/00

(52) U.S. Cl. 235/380

(57) ABSTRACT

A system and method to deliver detailed transaction information to financial account owner's mobile device per registered monetary transaction being imposed on their account so that the account owner is aware of the transaction activities associated with the financial account. Upon receipt of a monetary transaction being made on the account from the financial institution processing the transaction, the system obtains the address of a pre-collected mobile device from database, and communicates with a wireless network element, which in turn instructs the corresponding wireless network to send a message containing the transaction information to the mobile device associated with the financial account.

### REFERENCE CITED

### U.S. Patent Documents

U.S. Pat. No. 5,914,472 June 1999 Foladare et al. 235/380

U.S. Pat. No. 5,661,781 August 1997 DeJager 379/67

### BACKGROUND OF INVENTION

When a financial (credit/debit) card is presented to a merchant in order to purchase goods, or services, or simply for the purposes of distribution of currency, an electronic form of authorization by the financial card issuer is typically sought by the merchant. This is conventionally done via the transaction card authorization system in the financial networks. In these networks, typically the credit card reader device is used to take card information and send the charge request to the card issuer authorization system, which sends back a response either authorizing or rejecting the transaction to the originating device. The originating devices can be a credit card reader, an ATM (Automatic Teller Machine), or a credit card terminal allowing account number to be entered manually.

One of the problems with this mechanism is that fraudulent charges can be made on lost or stolen financial cards without cardholders” knowledge until days or weeks later, causing significant financial lost to, say credit card issuers and/or credit cardholder. In each of these cases, the card information or even the card itself is given to the merchant from sources other than the authorized card users for the purchase transaction being authorized. Another situation of fraudulent transactions is that lost or stolen financial cards are used to withdraw cash from an ATM if the associated Personal Identification Number (PIN) happens to be available. These are the examples where monetary loss might be the fault of neither the merchant nor the card authorization system.

A resolution to these problems is to give the credit card authorization system in the financial networks a way to notify electronically the credit card holder via a short message and/or Email containing detailed information on the transaction authorization to a pre-designated mobile device, such as mobile phone, pager, Personal Digital Assistant (PDA), when such a transaction is authorized on the card. This gives credit card holders instant knowledge of every transaction, i.e., charge, payment, withdraw, fund transfer, etc., being imposed on their cards.

In addition to the early detection of a fraudulent transaction, thus, minimizing the financial lost to card issuers, and/or cardholders, and/or merchants, several other benefits are realized by this resolution as well. For example, cardholders will be able to track autonomously and constantly the up-to-the-moment total transaction amount, the remaining balance of credit limit, etc. Also, the primary cardholder of the account will constantly be aware of charges made by secondary cardholders, e.g., his/her spouse and/or children, to the account. Furthermore, this resolution allows corporate account owners to monitor every transaction made by their employees to their accounts.

Needed is a new system and means to take the subscribed monetary transaction information given from the financial system in a financial network when such transaction occurs and deliver such information to financial account owner's mobile device. The system completes the latter step by sending the obtained transaction information together with the mobile device address to the appropriate network element in the wireless network to request such information be delivered to the designated mobile device.

### SUMMARY OF INVENTION

An objective of the present invention is to provide a system and method that automatically sends a message and/or Email containing subscribed monetary transaction information to the financial account owner's designated mobile device upon receipt of such information on the account from a financial institution. Typically, the address for the pre-designated mobile device was provided by the financial account owner to be used as the destination of a message notification per subscribed transaction made on the account. Examples of prevalent mobile device addresses are, but not limited to, mobile phone number, mobile IP address, and pager number. A database is also required to store the association of a financial account number to its corresponding mobile device address. Further, a second database is required to store the association of a mobile device address to its corresponding wireless network element.

### BRIEF DESCRIPTION OF DRAWINGS

In the drawings, FIG. 1 shows how the new system, called Wireless Data Delivery System (WDDS) and its associated databases, described in the invention connecting the financial network and the wireless network to communicate each financial transaction made on a financial account (e.g., credit card account, debit card account, checking/savings/investment account) to the account owner's mobile device. The WDDS is a logical entity providing a set of functionality, it might be a physical entity on its own or it might also share the same physical system with other sets of functionality.

FIG. 2 shows, in block diagram format, the high-level concept that bridges the financial network to the wireless network to allow transaction information originated from the financial network to be delivered to a mobile device.

FIG. 3 illustrates a database table that correlates a mobile device address to a financial account number.

FIG. 4 illustrates a database table that correlates a wireless service center to a mobile device address.

FIG. 5 illustrates the flow diagram showing the detailed steps used for bridging the financial network and the wireless network for delivering transaction information on a financial account to the account owner's registered and pre-designated mobile device.

### DETAILED DESCRIPTION

FIG. 1 shows a communication system arranged in accordance with the invention to allow each financial transaction information made on a financial account to be delivered to its owner's mobile device. The communication system includes the existing entities in both the financial and wireless networks bridged by the new entities claimed in the invention. As used herein, the term “financial account” or “account” refers to any type of monetary account including but not limited to: a) credit or smart card account, b) checking or savings account, and c) financial investment account. As used herein, the term “card” refers to any type of plastic rectangular-shaped mechanism used for accessing an account, including but not limited to: a) a commercial credit or smart card, b) a debit card, such as an Automated Teller Machine (ATM) card. As used herein, the term “monetary transaction” refers to any credit or debit transaction made to any financial account for purchase of merchandise, services, or distribution of currency. Also used herein, the term “mobile device address” refers to, but not limited to, mobile phone number, mobile IP address, and pager number. The term “wireless network” used herein refers to the network of known GSM, TDMA, CDMA, W-CDMA networks, including networks using other radio access standards such as paging network, satellite network and wireless data network. As used herein, the term “mobile device” refers to any type of mobile communication device including but not limited to mobile handset, Personal Digital Assistant (PDA) or pager. As used herein, the term “message” being sent to the mobile device includes but not limited to short text message, or electronic mail message, or enhanced mail message, or multimedia mail message.

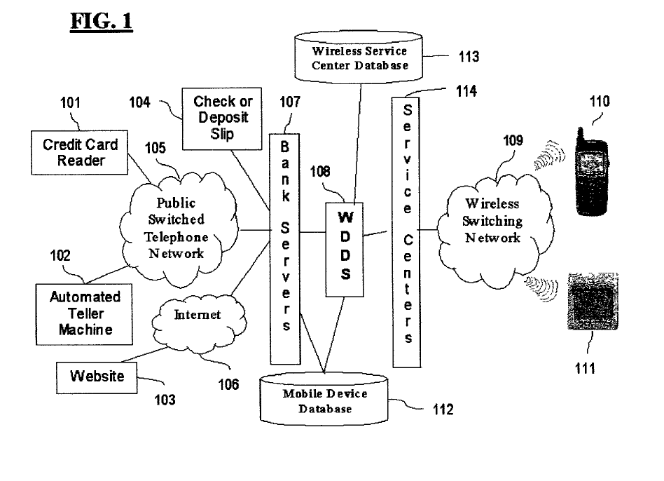

When a monetary transaction is initiated, the communication system of FIG. 1 executes three procedures as illustrated in FIG. 2, procedure 201 is executed in the financial network, procedure 203 is executed in the wireless network, and procedure 202 bridges procedures 201 and 203 to make the transaction information known and available to the wireless network.

When a monetary transaction is initiated from a card reader 101, an ATM 102, a website 103, or from a bank slip such as a written check, deposit slip, withdraw slip, fund transfer slip 104, procedure 201 is executed in the financial network where the information is typically sent to a bank server system 107 via a communication network, such as Public Switched Telephone Network (PSTN) 105 or the Internet 106, for processing. Other communication networks such as wireless network, public and private data networks, satellite networks, Virtual Private Network are also candidates to transmit the transaction information. For a transaction from a card reader 101, for example, a call is initiated via PSTN 105 to establish the connection with the bank server system after a card is swiped or an account number is entered together with the transaction amount. In contrast, the monetary transaction made on an ATM 102, a website 103, or in a bank slip 104 would normally trigger a data being sent via data network, e.g., Internet 106. Upon receipt of a transaction request, the bank server system 107 invokes the authorization procedure on the account. The bank server 107, usually owned, managed and/or controlled by card issuers, determines whether the transaction is authorized or rejected, and a corresponding response on the outcome of the transaction is sent back to transaction initiator.

In the wireless network, currently data to be delivered to a mobile device can be initiated from another mobile device or from a system external to the wireless network via a wireless service center 114 in the signaling network for processing. For example, to deliver a short message to a mobile handset, data is currently sent to an Short Message Service Center (SMS-C)—a computer system in the signaling network connecting to the wireless switching network 109—to be processed accordingly. Data together with a specific destination address, i.e., mobile device address received at the wireless service center 114 triggers procedure 203 to be executed in the wireless network, where the wireless service center 114 communicates with the appropriate systems in the wireless switching network 109 for data delivery. The destination mobile device might be a mobile handset 110 for a PDA 111 or a pager. Since wireless communication services are offered by various wireless carriers, it might require a different wireless service center to handle data delivery to a mobile device.

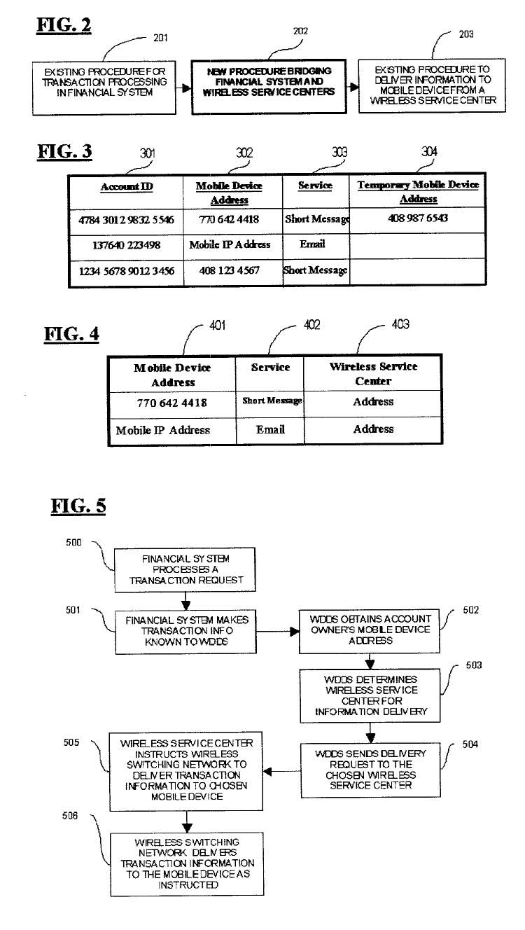

Procedure 202 in FIG. 2 is a new procedure to be executed to fill the gap between procedure 201 and procedure 203. Besides the transaction data that needs to be delivered, further needs are: a) a specific destination mobile device address; b) the type of delivery service, for example, short message or electronic mail; and c) a corresponding wireless service center serving the mobile device and capable of processing such data delivery. When the account owner registers for this delivery service, a mobile device address 302 and other service attributes associated with the account have been collected and stored in the Mobile Device Database 112 as detailed in FIG. 3. Associated with each financial account ID 301 is a list of service attributes including, but not limited to, the mobile device address 302 and the type of service delivery 303 pre-registered with the account ID 301. The temporary mobile device address 304 is another data attribute, which temporarily overrides the pre-registered mobile device address 302. The mobile device address 302 and temporary mobile device address 304 might be the mobile phone number of a handset, pager number, or the mobile IP address of a PDA. Wireless Service Center Database 113, as illustrated in FIG. 4, associates each mobile device address 401 with a wireless service center 403 serving that mobile device address for the desired type of service delivery 402 as indicated in 303 for the account. The mobile device address 401 is typically the same as the mobile device addresses listed in 302, except for those Account IDs 301 that instruct the WDDS 108 to use a temporary mobile device address 304. The wireless service center address 403 can be an IP address or other Network Element Addresses. Receipt of transaction information together with a mobile device address at the appropriate wireless service center triggers procedure 203 to be executed in the wireless network for data delivery.

Procedure 202 is detailed in FIG. 5. When the bank server 107 in step 500 processes a transaction on the account, the transaction information needs to be made known to the WDDS 108, as shown in step 501 if the transaction information is to be delivered to a mobile device. Step 501 involves a new mechanism in the bank server 107 to verify if an account has registered for service delivery in order to trigger this information transfer action. This mechanism can be achieved by either one of the following: a) adding a simple “yes/no” mark in the existing bank server database for the account, or b) consulting the Mobile Device database 112. If the bank server 107 has obtained data from b), the information sent to the WDDS 108 has both the transaction information (including the account ID) and the information stored in the Mobile Device database 112; otherwise only the transaction information (including the account ID) is sent.

Upon receipt of the information from bank server 107 for the transaction, step 502 is performed at the WDDS 108 to obtain the mobile device address for the account, either from the information received from the bank server 107 for the transaction or through This mechanism can be achieved by either one of the following: a) adding a simple “yes/no” mark in the existing bank server database for the account, or b) consulting the Mobile Device database 112. If the bank server 107 has obtained data from b), the information sent to the WDDS 108 has both the transaction information (including the account ID) and the information stored in the Mobile Device database 112; otherwise only the transaction information (including the account ID) is sent.

Upon receipt of the information from bank server 107 for the transaction, step 502 is performed at the WDDS 108 to obtain the mobile device address for the account, either from the information received from the bank server 107 for the transaction or through accessing the database 112. After getting all necessary information, the WDDS 108 executes step 503 to determine the appropriate service center in the wireless network for the information delivery service by consulting the Wireless Service Center database 113. WDDS then sends a request accordingly in step 504 to the indicated wireless service center found in step 503 to have the transaction information processed and delivered in steps 505 and 506 by the wireless switching network 109 to the mobile device address as indicated by the account owner.

1. A method of delivering transaction information on a monetary transaction being imposed to a financial account to the account owner's mobile device, the method comprising the steps of:
receiving the monetary transaction information together with the account information associated with a financial account;
associating the account information with a mobile device address and other delivery attributes associated with the account;
associating the mobile device address with a wireless delivery center in the wireless network; and
responsive to the receiving step and associating steps, outputting a message containing the mobile device address and the monetary transaction information to the appropriate wireless service center associated with the account for appropriate delivery.

2. The method of claim 1 wherein said financial account includes credit card or smart card account.

3. The method of claim 1 wherein said financial account includes bank account such as checking, savings or investment account.

4. The method of claim 1 wherein said monetary transaction includes transactions initiated from credit or smart cards.

5. The method of claim 1 wherein said monetary transaction includes transactions initiated from debit cards.

6. The method of claim 1 wherein said monetary transaction includes transactions initiated from bank slips.

7. The method of claim 1 wherein said monetary transaction includes debit and credit transactions made on financial accounts.

8. The method of claim 1 wherein said monetary transaction includes bank slips transactions made on checking, saving and investment accounts.

9. The method of claim 1 wherein said account information includes account unique identification and any of the followings: type of account, balances, mobile device address and type of delivery service.

10. The method of claim 1 wherein said transaction information includes amount, time, date, merchant identification and location, transaction authorization status (approved, rejected).

11. The method of claim 1 wherein said associating the account information with the mobile device address includes retrieving the mobile device address associated with the account from a database.

12. The method of claim 1 wherein said associating the account information with the mobile device address includes retrieving the mobile device address associated with the account in the account information received from the financial system processing the transaction.

13. The method of claim 1 wherein said associating the mobile device address with a wireless delivery center includes retrieving the wireless center address from a database.

14. The method of claim 1 wherein said mobile device includes mobile handset.

15. The method of claim 1 wherein said mobile device includes Personal Digital Assistant (PDA).

16. The method of claim 1 wherein said mobile device includes pager.

17. A system for delivering transaction information on a monetary transaction being imposed to a financial account to the account owner's mobile device, said system comprising:
a financial system having a account database table of the account owner” account information;
a central system having a mobile device database table that correlates an account with a mobile device address, and a wireless center database table that correlates a mobile device address with a wireless network element;
wherein said central system receives transaction information from the financial system;
wherein said central system obtains the mobile device address associated with each account that needs this message delivery service from its database table;
wherein said central system obtains the wireless network element associated with the mobile device address from its database table;
wherein said central system outputs the message request per transaction received to the appropriate wireless network element providing message service to the mobile device.

18. The system of claim 17 wherein said financial account includes credit card or smart card account.

19. The system of claim 17 wherein said financial account includes bank account such as checking, savings or investment account.

20. The system of claim 17 wherein said monetary transaction includes transactions initiated from credit or smart cards.

21. The system of claim 17 wherein said monetary transaction includes transactions initiated from debit cards.

22. The system of claim 17 wherein said monetary transaction includes transactions initiated from bank slips.

23. The system of claim 17 wherein said monetary transaction includes debit and credit transactions made on financial accounts.

24. The system of claim 17 wherein said monetary transaction includes bank slips transactions made on checking, saving and investment accounts.

25. The system of claim 17 wherein said database tables are tables in a single database or multiple databases; wherein the databases are in the financial system, or the central system, or another independent system.

26. The system of claim 17 wherein said financial system and central system are components of a single processor or multiple processors connected by a network.

27. The system of claim 17 wherein said outputting message includes short message, short Email, enhanced message, and multimedia message.

28. The system of claim 17 wherein said outputting message request includes message to mobile handsets.

29. The system of claim 17 wherein said outputting message request includes message to Personal Digital Assistants (PDA).

30. The system of claim 17 wherein said outputting message request includes message to pagers.
